(19) United States
(12) Patent Application Publication
(10) Pub. No.: US 2005/0003174 A1
(43) Pub. Date: Jan. 6, 2005

(54) Wallpaper and method for producing thereof

(76) Inventors: Hideki Ikeda, Fuji-city (JP); Setsuo Toyoshima, Ichikawa-city (JP)

Correspondence Address: ARMSTRONG, KRATZ, QUINTOS, HANSON & BROOKS, LLP, 1725 K STREET, NW, SUITE 1000, WASHINGTON, DC, 20006, US

(21) Appl. No.: 10/864,885

(22) Filed: Jun. 10, 2004

(30) Foreign Application Priority Data
Jun. 16, 2003 (JP) 2003-170531 (PAT.
Dec. 18, 2003 (JP) 2003-420560 (PAT.

(51) Int. Cl. B32B 27/04; B32B 5/02; B32B 27/12

(52) U.S. Cl. 428/219; 442/394; 442/79

(57) ABSTRACT

A wallpaper having a laminated structure comprising a mat finishing film layer formed of a thermoplastic resin film or a front nonwoven fabric layer with printability, stacked thereon a water-repellent pulp fibrous nonwoven fabric layer having a bulk density of 0.05 to 0.3 g/cm³, stacked thereon a polyolefin-laminated backing paper layer, wherein the adhesion of each layer is accomplished by a hot-melt bonding, characterized in that said mat finishing film layer or said front nonwoven fabric layer has a concave-convex pattern formed by applying heat-embossing treatment to said mat finishing film layer side or said front nonwoven fabric layer side is provided.

### FILED OF THE INVENTION

The present invention relates to a decorative wallpaper which is used by attaching it to a wall or ceiling surface for the purpose of interior decoration. More specifically, the present invention relates to a wallpaper excellent in processability and applicability, free from generation of endocrine-disrupting chemicals, ensured with weathering resistance and capable of maintaining the decorative property over a long period of time.

### PRIOR ART

An expanded and embossed vinyl chloride wallpaper obtained by coating an expandable vinyl chloride resin paste on a backing paper and then expanding the coated film under heat to represent an embossed pattern is inexpensive, shows good plasticity and flexibility, as well as provides a voluminous texture. Moreover, as the coated film thereof has moisture impermeability, the amount of the water from the glue used for the application which evaporates and passes through the wallpaper in the course of carrying out the application can be reduced, and thus it exhibits good applicability. From these and other advantageous points, such a wallpaper is being widely used.

However, the vinyl chloride resin has problems in that, as it comprises a plasticizer, the plasticizer bleeds out in aging and stains the wallpaper surface, or in the case of fire or when incinerating the wallpaper as a waste, noxious gas such as hydrogen chloride gas or black smoke is generated. A wallpaper comprising an ethylene-vinyl acetate copolymer in place of such a vinyl chloride resin has been proposed (Japanese Unexamined Patent Publication No. 58-4879). However, in the case of using an ethylene-vinyl acetate copolymer, an extent of expansion as high as that of the vinyl chloride wallpaper cannot be obtained, which results in a poor voluminous texture. Also, there may arise a problem such as change in color due to contact with plastic materials.

On the other hand, a wallpaper obtained by laminating a surface decorated paper onto a backing paper through a hot melt resin layer extruded from an extruder has also been proposed, where the glue used for application is prevented from drying by virtue of the resin layer, thereby allowing the extension of the time to carry out the application (Japanese Examined Utility Model Publication No. 61-20076). However, as the surface thereof is made of a paper layer, regarding such a wallpaper, it is difficult to apply a treatment to form concaves and convexes thereon, and thus a high grade-appearance, which is possessed by the wallpaper formed from an expandable and embossable vinyl chloride resin paste having embossed pattern thereon, can hardly be accomplished.

In addition, a pulp fiber wallpaper obtained by laminating a pulp fibrous nonwoven fabric onto a backing paper through a hot melt resin laminated layer, and then laminating a thermoplastic resin-surface protecting film layer onto the nonwoven fabric layer has been proposed, where concaves and convexes are formed on the surface protecting film layer by hot press embossing (Japanese Unexamined Patent Publication No. 10-204783).

This is a good wallpaper, excellent in processability and applicability, free from generation of noxious gas at the burning, and endowed with voluminous texture by virtue of high bulkiness of the pulp fibrous nonwoven fabric.

However, in the course of preparing the laminated structure of this wallpaper, the bonding between the pulp fibrous nonwoven fabric layer and the backing paper layer prior to the hot press embossing step is accomplished by a hot press bonding step via a hot melt resin-laminated layer and, also, the bonding between the pulp fibrous nonwoven fabric and the surface protecting film layer is accomplished by a press-bonding step by use of an emulsion adhesive. Therefore, it is inevitable for the pulp fibrous nonwoven fabric layer to undergo bulk reduction due to the pressure applied and the water invading in the course of carrying out the interlayer bonding steps. This reduction in the bulk of the nonwoven fabric layer is disadvantageous for the subsequent formation of a concave-convex pattern, by heat embossing, so as to provide concave-convex pattern having soft and thick convex regions, necessary for exhibiting voluminous texture and a high-grade appearance.

In recent years, accompanying the differentiation of wallpapers, a paper-based wallpaper having a paper or pulp nonwoven fabric on its surface has been proposed as wallpaper matching a private room. This paper-based wallpaper is environment-friendly because noxious gases are not generated and a plasticizer or the like is not used, and at the same time, the warmth of a naturally occurring material and good fitting to a Japanese-style room design or the like are ensured. Therefore, this is attracting attention as an environment-friendly wallpaper for taking the place of vinyl wallpaper.

However, the paper-based wallpaper has a problem in that, as the paper or pulp nonwoven fabric material has a high density, and thus provides a rigid wallpaper, its attachment is difficult due to its poor flexibility, and the height of the embossing is difficult to increase, resulting in a poor voluminous texture. Also, as the paper or pulp nonwoven fabric undergoes considerable expansion and contraction after being subjected to wet and dry environments, its application is difficult and the joining parts of the wallpaper pieces tend to part. From these reasons, the paper-based wallpaper is shunned by contractors.

### DISCLOSURE OF THE INVENTION

An object of the present invention is to provide a wallpaper which is a vinyl chloride-free wallpaper not containing a plasticizer and a halogen, and which is favored with plasticity, flexibility, voluminous texture and high-grade appearance comparable with the vinyl chloride-based wallpaper, ensures excellent applicability and can maintain the surface decorative property over a long period of time.

The present invention, which accomplishes the above-described object, relates to a wallpaper obtained by forming a concave-convex pattern by applying heat embossing treatment onto a wallpaper stock paper, without impairing the bulkiness of nonwoven fabric, and includes the following inventions:

(1) A wallpaper having a laminated structure comprising a mat finishing film layer formed of a thermoplastic resin film or a front nonwoven fabric layer with printability, stacked thereon a water-repellent pulp fibrous nonwoven fabric layer having a bulk density of 0.05 to 0.3 g/cm³, stacked thereon a polyolefin-laminated backing paper layer, wherein the adhesions of each layer are accomplished by a hot-melt bonding, characterized in that said mat finishing film layer or said front nonwoven fabric layer has a concave-convex pattern formed by applying heat-embossing treatment to said mat finishing film layer side or said front nonwoven fabric layer side.

(2) The wallpaper according to (1), wherein said water-repellent pulp fibrous nonwoven fabric layer having a bulk density of 0.05 to 0.3 g/cm³ in said laminated structure is a layer consisting of an air-laid nonwoven fabric having a thickness of 500 to 2,000 μm formed from pulp fibers bonded with an acrylic binder which has a water-repellent group or which comprises a water-repelling agent, but does not comprise any formaldehyde-generating source.

(3) The wallpaper according to (1) or (2), wherein said mat finishing film layer formed of a thermoplastic resin film comprises an unstretched polyethylene or polypropylene film having a basis weight of up to 30 g/m², the back side thereof forms a weathering resistant printable surface formed by application of a corona discharge treatment thereto.

(4) The wallpaper according to any of (1) to (3), wherein the mat finishing film layer of a thermoplastic resin film comprises a film in which the film layer is imparted with a light-scattering property by forming the film layer from a resin composition comprising a thermoplastic resin having added thereto a pigment such as titanium oxide, calcium carbonate, silica, talc or the like, or by forming the film layer from a resin composition comprising at least one thermoplastic resin having added thereto another resin having incompatibility with the thermoplastic resin, or by forming concaves and convexes on the surface of the film layer by physical pressurizing means such as embossing at the production of the thermoplastic resin film, or by applying other surface-roughening treatments.

(5) The wallpaper according to (1) or (2), wherein said front nonwoven fabric layer with printability comprises a wet nonwoven fabric having a basis weight of up to 30 g/m² and a bulk density of at least 0.2 g/cm³, with a weathering resistant printable surface formed on its front surface.

(6) The wallpaper according to (5), wherein said wet nonwoven fabric contains at least 50 mass % of hemp pulp.

(7) The wallpaper according to any of (1) to (6), wherein said adhesion accomplished by a hot-melt bonding is carried out by supplying a hot-melt adhesive between each surface by means of a fibrous curtain coating system.

(8) The wallpaper according to any of (1) to (7), wherein said polyolefin-laminated backing paper layer is formed by melt-extruding the polyolefin material with an extruder onto the surface of said backing paper adjacent to said nonwoven fabric layer, followed by lamination.

(9) The wallpaper according to any of (1) to (8), wherein the heat embossing treatment comprises, after-the step of forming the laminated structure comprising the thermoplastic resin film or the front nonwoven fabric layer, stacking thereon the fibrous nonwoven fabric layer, stacking thereon the polyolefin-laminated backing paper layer, applying heat embossing to the thermoplastic resin film layer side or the front nonwoven fabric layer side to form a concave-convex pattern having a large difference of altitude.

(10) The wallpaper according to any of (1) to (9), wherein the polyolefin-laminated backing paper layer has a concealing polyolefin-laminated layer formed by melt-extruding the polyolefin material having added thereto a pigment such as titanium oxide, aluminum oxide, calcium carbonate or the like, by an extruder onto the backing paper surface, followed by lamination.

(11) A method for producing a wallpaper, comprising the following steps:
adhesion of a polyolefin-laminated backing paper onto a water-repellent pulp fibrous nonwoven fabric having a bulk density of 0.05 to 0.3 g/cm³, and
adhesion of said water-repellent pulp fibrous nonwoven fabric onto a mat finishing film layer formed of a thermoplastic resin film or a front nonwoven fabric layer with printability,
wherein the adhesions of each layer are accomplished by a hot-melt bonding, whereby producing a laminated structure, followed by
application of a heat-embossing treatment to said laminated structure at said mat finishing film layer side or at said front nonwoven fabric layer side to form a concave-convex pattern, whereby said wallpaper has a low-bulk density nonwoven fabric layer within the convex regions.

(12) The method for producing a wallpaper according to (11), wherein the mat finishing film layer formed of a thermoplastic resin film or the front nonwoven fabric layer with printability comprises a film in which the film layer is imparted with light-scattering property by forming the film layer from a resin composition comprising a thermoplastic resin having added thereto a pigment such as titanium oxide, calcium carbonate, silica, talc or the like, or by forming the film layer from a resin composition comprising at least one thermoplastic resin having added thereto another resin having no compatibility with the thermoplastic resin, or by forming concaves and convexes on the surface of the film layer by physical pressurizing means such as embossing at the production of thermoplastic resin film, or by applying other surface-roughening treatments.

(13) The method for producing a wallpaper according to (12), wherein said adhesion accomplished by a hot-melt bonding is carried out by supplying the hot-melt adhesive between each surface by means of a fibrous curtain coating system.

### BEST MODE FOR CARRYING OUT THE INVENTION

The wallpaper of the present invention has a laminated structure which is formed by stacking and bonding a thermoplastic resin film layer or a front nonwoven fabric layer with printability onto one surface of a highly bulky nonwoven fabric layer by a hot-melt bonding, and stacking and bonding a polyolefin-laminated backing paper layer comprising a weldable polyolefin extrusion layer laminated on one surface of a paper sheet of a backing paper onto the other surface of the nonwoven fabric layer by a hot-melt bonding with the extrusion layer being facing inside (i.e. facing the nonwoven fabric layer side), and after forming the laminated structure, heat embossing is applied to the thermoplastic resin film layer side or the front nonwoven fabric layer side.

The nonwoven fabric for use in the wallpaper of the present invention is not critical, as long as it shows good plasticity and flexibility and, at the same time, is non-hygroscopic and has high bulkiness. Examples of the nonwoven fabric which can be used include a spun-bonded nonwoven fabric, a spun-laced nonwoven fabric, a wet nonwoven fabric and an air-laid nonwoven fabric. Among these, preferred is an air-laid nonwoven fabric, because the entire nonwoven fabric can be easily water repellent-treated in the production step, and a nonwoven fabric having excellent bulkiness can be produced therefrom, and more preferred is an air-laid nonwoven fabric produced by spraying a water-repellent adhesive solution onto a layer formed by stacking fibers mainly comprising a pulp fiber. As for the water-repellent adhesive, an acrylic adhesive which has a water-repellent group in itself, or an acrylic adhesive comprising a water-repelling agent, and not containing any crosslinking agent as a formaldehyde-generating source, is used.

The air-laid nonwoven fabric, particularly, the air-laid nonwoven fabric formed from fibers mainly comprising a pulp fiber, is used for imparting a desired voluminous texture to the wallpaper and, therefore, an air-laid nonwoven fabric having a bulk density of approximately from 0.05 to 0.3 g/cm³, a thickness of 300 to 2,500 μm, preferably from 500 to 2,000 μm, and a basis weight of 30 to 120 g/m², preferably on the order of 40 to 80 g/m², is usually used. In the air-laid nonwoven fabric, the fiber surface is water repellent-treated by spraying thereon a water-repellent acrylic adhesive and, therefore, this is rendered to a liquid-sparingly-permeable layer, though the fiber is a hydrophilic pulp fiber.

In one embodiment, on the wallpaper surface side of the highly bulky nonwoven fabric, a thermoplastic resin film, preferably an unstretched polyethylene or unstretched polypropylene film, is stacked by use of a melted state fibrous hot-melt adhesive supplied between the two layers. The bonding by a hot-melt adhesive does not require a strong pressure and, therefore, the two layers can be bonded without impairing the high bulkiness of the nonwoven fabric, so that even when the thickness of the entire nonwoven fabric layer is decreased by the subsequent heat embossing, the nonwoven fabric layer in the formed convex part can be maintained at a sufficiently low bulk density and by virtue of a concave-convex pattern having a voluminous texture and a large difference of altitude, a high-grade appearance surface excellent in the decorative property can be formed.

The surface of the thermoplastic resin film is made non-lustrous by mat finishing. Also, for imparting embossing suitability and reducing the total heat value at the burning, the basis weight is preferably 30 g/m² or less. The thermoplastic resin film is preferably an unstretched film, because a concave-convex pattern can be easily formed on the surface by embossing.

The thermoplastic resin film can contain additives, such as a pigment, capable of imparting a decorative property and high-grade appearance. Also, from the standpoint of imparting a long-term weathering resistance, a light stabilizer may be added in the film.

The back surface of the thermoplastic resin film, where printability is imparted by a corona discharge treatment or the like, may be further subjected to a pattern printing by using a weathering-resistant and moisture-resistant printing ink so as to enhance the high-grade appearance and decorative property in a high degree.

In another embodiment, the front nonwoven fabric with printability is bonded onto one surface of a highly bulky nonwoven fabric by a hot-melt bonding. The bonding by a hot-melt adhesive does not require a strong pressure and therefore, two layers can be bonded without impairing the high bulkiness of the nonwoven fabric. Also, even when the thickness of the entire nonwoven fabric layer is decreased by the subsequent heat embossing, the nonwoven fabric layer in the formed convex part can be maintained at a sufficiently low bulk density and, by virtue of a concave-convex pattern having a voluminous texture and a large difference of altitude, a high-grade appearance surface with a superior decorative property can be formed.

The front nonwoven fabric has printability and printable surface strength and therefore, this is preferably a wet nonwoven fabric having a relatively high surface smoothness, more preferably a pulp nonwoven fabric having blended therein a heat-bondable synthetic fiber having a low basis weight and high strength characteristics with a bulk density of at least 0.2 g/cm³, or a pulp nonwoven fabric having blended therein a hemp pulp with large fiber length and high strength characteristics. In view of the strength, the blending ratio of the hemp pulp is preferably at least 50 mass %. The surface nonwoven fabric can be subjected to surface printing before bonding to the highly bulky nonwoven fabric or after being integrated into the wallpaper laminated structure. Also, for imparting embossing suitability and reducing the total heat value at the burning, the basis weight is preferably 30 g/m² or less.

The front nonwoven fabric can contain additives such as a pigment capable of imparting a decorative property and a high-grade appearance. In addition, for the purpose of preventing staining after printing, the surface of the front nonwoven fabric layer may be subjected to a water-repelling agent coating or a clear coating.

The polyolefin-laminated backing paper for use in the wallpaper of the present invention has a laminated structure in which the polyolefin resin film providing a barrier layer capable of prolonging the open time of a pressure-sensitive adhesive layer used for sticking the wallpaper to the wall surface, is laminated on the paper substrate (backing layer) surface having a function of concealing the basic surface being applied to the wall surface.

As the paper substrate (backing paper) for use in the laminated backing paper, by taking account of concealing of the basic surface being applied to the wall surface and coating of the glue for application, a paper substrate having a basis weight of 50 to 100 g/m² can be suitably used. Also, a flame retarder may be added to the paper substrate so as to render the wallpaper flame-retardant.

The laminated backing paper may be one comprising various resins such as ethylene-vinyl acetate resin, polyester resin or the like, but a melt-extrusion laminated backing paper comprising a melt-bonding polyolefin resin is preferred, because of the reduced amount of smoke generated when burning the nonwoven fabric-containing wallpaper, as well as its excellent melt-extrusion suitability and good adhesiveness in lamination. Incidentally, the concealing property can also be imparted by adding a pigment such as titanium oxide, aluminum oxide, calcium carbonate or the like to the laminated layer. The weldable polyolefin resin for the formation of the weldable extrusion laminated layer is preferably a polyethylene resin.

The concealing laminated layer may also be formed by laminating a polyolefin film imparted with the above-described concealing property on a backing paper with an adhesive.

The thickness of the polyolefin-laminated layer in the concealing laminated backing paper is usually from 5 to 30 μm. If the thickness is less than 5 μm, pinholes are readily formed and this may impair the function as a moisture-impermeable water-resistant layer for preventing the transfer of the moisture in the glue used for application to the nonwoven fabric side in the course of carrying out the application, whereas if it exceeds 30 μm, the nonwoven fabric-containing wallpaper becomes entirely rigid and it is difficult to carry out the application while following the irregularities on the wall surface base and also, the heat value at the burning disadvantageously increases.

The wallpaper of the present invention is not particularly limited in the total thickness. The total thickness is from 0.3 to 1.5 mm as required for a normal wallpaper, preferably from 0.5 to 1.0 mm. If the total thickness is less than 0.3 mm, use of a highly bulky nonwoven fabric for imparting a high-grade appearance to the wallpaper becomes meaningless and deep concaves and convexes having a large difference of altitude are disadvantageously difficult to form, whereas if the thickness exceeds 1.5 mm, the wallpaper becomes entirely rigid and it is difficult to carry out the application following the irregularities on the wall surface base.

Examples of the hot-melt adhesive which can be used for bonding the nonwoven fabric to the thermoplastic resin film layer or the front nonwoven fabric layer and to the concealing polyolefin-laminated backing paper in the wallpaper of the present invention includes conventional hot-melt adhesives such as polyolefin-, polyurethane-, EVA-, polyamide-, rubber-based hot-melt adhesives and the like. Among these, hot-melt adhesives having excellent photo-resistance are preferred for maintaining the decorative property for a long period of time. The hot-melt adhesive is not critical with respect to the shape of the hot-melt adhesive layer as long as it can be supplied, in a melted state, between the highly bulky nonwoven fabric and the backing paper or between the highly bulky nonwoven fabric layer and the thermoplastic resin film layer or the front nonwoven fabric layer. The hot-melt adhesive may be supplied in the form of film, line, network or the like, but a melted hot-melt adhesive is preferably supplied in the form of a fiber between layers by means of a fibrous curtain coating system to bond the layers.

The laminated structure, formed after supplying the melted hot-melt adhesive between the layers, is passed through rollers under weak pressure to bond the respective layers. At this time, the weak pressure-applying condition is one to accomplish the bonding in a manner that the highly bulky nonwoven fabric layer is not compressed to a degree that impairs the high bulkiness. The condition in terms of clearance in the pressing step is selected from the range of −0.1 to −0.3 mm with respect to the total thickness of the laminated structure.

In the nonwoven fabric-containing wallpaper of the present invention, the bonding of the concealing polyolefin-laminated backing paper layer and the thermoplastic resin film layer or the front nonwoven fabric layer to respective surfaces of the highly bulky nonwoven fabric layer is accomplished with a hot-melt adhesive supplied in the melted state between the layers, so that the layers can be stacked and bonded with a gentle pressing force, and a wallpaper laminated structure maintaining the high bulkiness of the highly bulky nonwoven fabric can be produced.

Also, by virtue of the cushioning property of the highly bulky nonwoven fabric layer, a deep and tall concave-convex pattern having a sufficiently large difference in height can be formed by applying heat embossing to the laminated structure at the thermoplastic film layer side or the front nonwoven fabric layer side, and as a result, a wallpaper having plasticity, flexibility and voluminous texture and having a surface with excellent high-grade appearance can be provided.

Furthermore, when the thermoplastic resin film layer is a polyethylene or polypropylene film layer, its surface is low in the wettability and therefore, soiling resistance is obtained. In addition, as the weldable resin-laminated layer interposed between the nonwoven fabric layer and the backing paper layer is a moisture-impermeable water-resistant barrier layer, the glue used for application is prevented from penetrating into the nonwoven fabric layer in the course of carrying out the application, and the water in the glue scarcely evaporates from the surface, so that an extended open time can be allowed, after coating of the glue for application, which facilitates the application.

Also, a polyolefin resin or pulp nonwoven fabric is used and this is advantageous in that the amount of smoke and noxious gas generated at an incineration process can be reduced.

Furthermore, the nonwoven fabric layer is water-repellent, so that when applying and attaching several wallpapers, the joint parts of the wallpaper pieces would not be affected by the moisture included in the glue, and even when a water droplet is formed on or attached onto the wall surface due to dewing or the like, excellent durability is exhibited, and moisture existed at the edges of the wallpaper pieces does not penetrate in between the layers.

### EXAMPLES

The constitution of the nonwoven fabric-containing wallpaper of the present invention and the effects provided by the present wallpaper are described in greater detail below by referring to Examples, however, the present invention should not limited to these Examples.

### Example 1

Pulp fibers (NBKP, produced by Oji Paper Co., Ltd.) having a fiber length of 0.05 to 5 mm were spread out from a pulp mat former to form a layered mat having a basis weight of 45 g/m², and then an aqueous binder solution containing 29.8 parts by mass of acrylic adhesive (“Nipol LX845”, trade name, produced by ZEON Corporation) and 0.2 parts by mass of a water-repelling agent (“Asahi Guard”, trade name, produced by Asahi Glass Company, Ltd.) was sprayed thereon to form a pulp fibrous air-laid nonwoven fabric having a basis weight of 75 g/m², a bulk density of 0.075 g/cm³ and a thickness of 1.0 mm.

Separately, a surface of a polyethylene resin film (“WS-21N”, produced by Fukusuke Kogyo Co., Ltd., thickness prior to subjecting to a mat finishing procedure: 21 μm, thickness after being subjected to the mat finishing procedure: 38 μm, basis weight: 19.5 g/m²) was subjected to a mat finishing procedure during the cooling stage when extruded out of a T die by cool-pressurizing the film with a metal roll having 180 wires, after which, at its back surface, it was subjected to a corona discharge treatment, and then to gravure printing to form a front film layer.

Also, separately, a resin composition obtained by adding 18 parts by mass of a masterbatch (“PEX3004WHITE”, produced by Tokyo Printing Ink Mfg. Co., Ltd.) containing titanium oxide and aluminum oxide as pigments to 100 parts by mass of low-density polyethylene resin (“MIRASON”, trade name, produced by Mitsui Petrochemical Industries, Ltd.) was melt-extruded and laminated to a thickness of 10 μm on a backing paper (“NN-65KO”, trade name, produced by Kishu Seishi Pulp Co., Ltd.) having a basis weight of 65 g/cm³ and a thickness of 110 μm, to form a 120 μm-thick laminated paper as a concealing polyolefin-laminated layer.

The thus-obtained film for the front layer and the concealing polyolefin-laminated backing paper were stacked on one surface of the air-laid nonwoven fabric and on the opposite surface, respectively, each with a polyolefin-based hot-melt adhesive (“MP7856”, trade name, produced by Nippon NSC) in a coated amount of 7 g/m² by means of a hot-melt fibrous curtain coating apparatus (manufactured by Suntool Corporation) to form a wallpaper laminated material having a laminated structure comprising the concealing polyethylene-laminated backing paper layer/pulp fibrous nonwoven fabric layer (bulk density: 0.09 g/cm³)/polyethylene film surface layer, and having an entire thickness of 1.0 mm.

The obtained wallpaper stock was embossed by a heat embosser from the polyethylene film surface layer side to form a concave-convex pattern having a gentle slope with a difference in height of 500 μm (thickness of the convex region: 750 μm), thereby producing a pulp fibrous nonwoven fabric-containing wallpaper.

### Example 2

A pulp fibrous nonwoven fabric-containing wallpaper was produced in the same manner as in Example 1 except that a resin composition obtained by adding 1 part by mass of titanium oxide to 100 parts by mass of polyethylene resin, and as the film for the front layer, a polyethylene resin film (“WS-21F”, produced by Fukusuke Kogyo Co., Ltd., thickness prior to subjecting to a mat finishing procedure: 21 μm; thickness after subjected to the mat finishing procedure: 38 μm, basis weight: 19.6 g/m²) was used, the surface being mat finished during the cooling stage when extruded out of a T die by cool-pressurizing treatment with a metal roll having 180 wires, and its back surface being subjected to a corona discharge treatment and then to a gravure printing.

### Comparative Example 1

A pulp fibrous nonwoven fabric-containing wallpaper was produced in the same manner as in Example 1 except that respective layers were press-bonded by using an ethylene-vinyl acetate emulsion adhesive (“POLYSOL EVA. AD-68”, trade name, produced by Showa Highpolymer Co., Ltd.) in a coated amount of 20 g/m² in place of the hot-melt adhesive used in Example 1.

### Comparative Example 2

A pulp fibrous nonwoven fabric-containing wallpaper was produced in the same manner as in Example 1 except that, instead of the use of a hot-melt adhesive in the backing paper side of Example 1, a low-density polyethylene resin (“PETROTON”, trade name, produced by Tosoh Corporation) extruded by an extruder was melt-extruded between the backing paper layer and the pulp fibrous nonwoven fabric layer, and then these layers were subjected to press-lamination.

Application Test:

Each of the pulp fiber wallpapers of Examples 1 and 2 was applied to a wall surface by using a starch-based glue for application. As a result, these wallpapers exhibited the same plasticity and flexibility as those of conventional vinyl chloride wallpapers, a folding habit as encountered in conventional paper-based wallpapers was not retained, the glue used for application coated in the course of the application was prevented from dissipating during standing in the state of the coated back surfaces being superposed with each other, an open time of 24 hours or more could be taken, and applicability equal to that of vinyl chloride wallpaper was verified. In the burning test of these pulp fiber wallpapers, the smoking and heat value at the burning were small and noxious halogen gas as seen in the case of vinyl chloride wallpaper was not generated.

Furthermore, the nonwoven fabric layer in the wallpaper stock paper underwent less reduction in the bulk density, a deep and tall concave-convex pattern was formed by heat embossing, the convex part had soft touch, and a wallpaper having high-grade appearance was formed.

On the other hand, in the case of the pulp fiber wallpaper of Comparative Example 1, particularly, the emulsion adhesive penetrated into the nonwoven fabric layer of the wallpaper stock, the nonwoven fabric layer was reduced in the bulk density to 0.32 g/cm³ by press-bonding and fixed in this state, and the entire thickness was also decreased to 0.4 mm. Due to this reduction in the thickness, the depth of concave and convex by heat embossing on the surface layer of the wallpaper stock was restricted and the voluminous texture was lost, and as a result, a wallpaper decreased, as a whole, in high-grade appearance was obtained.

In the case of the pulp fiber wallpaper of Comparative Example 2, the nonwoven fabric layer in the wallpaper stock was compressed by press-bonding to cause reduction in the bulk density to 0.20 g/cm³ and the entire thickness was also decreased to 0.5 mm. Due to this reduction in the thickness, the depth of concave and convex by heat embossing on the surface layer was restricted and the voluminous texture was lost and, as a result, a wallpaper entirely showing an impaired high-grade appearance was obtained.

As is apparent from these results, the nonwoven fabric-containing wallpaper of the present invention has a structure that a polyolefin-laminated backing paper layer and a thermoplastic resin film layer are bonded on respective surfaces of a highly bulky nonwoven fabric layer each by using a hot melt adhesive to form a laminated structure, therefore, a high pressing force is not necessary at the stacking and bonding for the production of a wallpaper stock and the high bulkiness of the nonwoven fabric layer is not impaired, so that a concave-convex pattern having a gentle slope with a sufficiently large difference of altitude can be formed on the thermoplastic resin film in the front side of the wallpaper stock with heat embossing by virtue of the cushioning property of the nonwoven fabric layer. As a result, a soft and voluminous wallpaper having a high-grade appearance surface can be constituted.

Furthermore, the melt-bonding resin-laminated layer of the backing paper layer is moisture impermeable and water-resistant layer, and therefore, the glue used for application does not penetrate into the nonwoven fabric layer and the moisture included in the glue is scarcely evaporated from the surface, so that a sufficiently long open time is allowed after coating of the glue for application.

In addition, the nonwoven fabric layer is water-repellent and does not allow penetration of water from the edges of the wallpaper pieces, and therefore, excellent durability is attained.

### Example 3

Pulp fibers (NBKP, produced by Oji Paper Co., Ltd.) having a fiber length of 0.05 to 5 mm were spread out from a pulp mat former to form a layered mat having a basis weight of 33 g/m², and an aqueous binder solution containing 17 parts by mass of acrylic adhesive (“Nipol LX845”, trade name, produced by ZEON Corporation) was sprayed thereon to form a pulp fiber air-laid nonwoven fabric having a bulk density of 0.071 g/cm³ and a thickness of 0.7 mm.

A wet nonwoven fabric (“KABEGAMI GENSHI”, produced by Oji Paper Co., Ltd., basis weight: 17 g/m², bulk density: 0.24 g/cm³, thickness: 72 μm) was used as the front nonwoven fabric with printability, and this fabric was subjected to surface printing by gravure printing and further to a soil-proofing treatment by coating a water-repelling agent on its surface.

Also, separately, a resin composition obtained by adding 18 parts by mass of a masterbatch (“PEX3004WHITE”, produced by Tokyo Printing Ink Mfg. Co., Ltd.) containing titanium oxide and aluminum oxide as pigments to 100 parts by mass of low-density polyethylene resin (“MIRASON”, trade name, produced by Mitsui Chemicals, Inc.) was melt-extruded and laminated to a thickness of 10 μm on a backing paper (“NN-65KO”, trade name, produced by Kishu Seishi Pulp Co., Ltd.) having a basis weight of 65 g/cm³ and a thickness of 110 μm to form a 120 μm-thick laminated paper as a concealing polyolefin-laminated layer.

The thus-obtained surface-printed nonwoven fabric and concealing polyolefin-laminated backing paper were stacked on one surface of the air-laid nonwoven fabric and on the opposite surface, respectively, each with a polyolefin-based hot-melt adhesive (“MP7856”, trade name, produced by Nippon NSC) in a coated amount of 4 g/m² for the surface-printed nonwoven fabric and 7 g/m² for the concealing polyolefin-laminated backing paper by a hot-melt fibrous curtain coating apparatus (manufactured by Suntool Corporation) to form a wallpaper laminated material having a laminated structure comprising the concealing polyethylene-laminated backing paper layer/pulp fibrous nonwoven fabric layer (bulk density: 0.10 g/cm³)/surface-printed non-woven fabric layer, and having an entire thickness of 0.7 mm.

The obtained wallpaper stock was embossed by a hot embosser from the surface-printed non-woven fabric layer side to form a concave-convex pattern having a gentle slope with a difference of altitude of 330 μm (thickness of convex part: 580 μm), thereby producing a pulp fibrous nonwoven fabric-containing wallpaper.

### Example 4

A pulp fiber-containing wallpaper was produced in the same manner as in Example 1, except that a wallpaper laminated material having an entire thickness of 0.7 mm was produced by using, as the surface non-woven fabric with printability, a wet non-woven fabric (“HEATRON GSP”, trade name, basis weight: 20 g/m², bulk density: 0.27 g/cm³, thickness: 74 μm, produced by Nippon Daishowa Paperboard Co., Ltd., stock paper for tea bag), and the surface of the wallpaper laminated material was subjected to gravure printing and water-repellent treatment.

### Comparative Example 3

A pulp fibrous nonwoven fabric-containing wallpaper was produced in the same manner as in Example 1, except that respective layers were press-bonded by using an ethylene-vinyl acetate emulsion adhesive (“POLYSOL EVA. AD-68”, trade name, produced by Showa Highpolymer Co., Ltd.) in a coated amount of 20 g/m² in place of the hot-melt adhesive in Example 3.

### Comparative Example 4

A pulp fibrous nonwoven fabric-containing wallpaper was produced in the same manner as in Example 1, except that a wallpaper stacked material was produced by using a spun-lace non-woven fabric (“TEXELFLASH”, trade name, thickness: 250 μ, produced by Oji Paper Co., Ltd.) comprising rayon fiber/wood pulp and having a basis weight of 50 g/m² in place of the stacked material of air-laid non-woven fabric and the front non-woven fabric in Example 3, and it was stacked with the concealing polyolefin-laminated backing paper, and the surface of the wallpaper stacked material was subjected to gravure printing and water-repellent treatment.

Application Test:

Each of the pulp fiber wallpapers of Examples 3 and 4 was applied to a wall surface by using a starch-based glue for application. As a result, these wallpapers exhibited the same plasticity and flexibility as those of conventional vinyl chloride wallpapers, a folding habit as encountered in conventional paper-based wallpapers was not retained, the glue used for application was prevented from dissipating during standing in the state of the coated back surfaces being superposed with each other, an open time of 24 hours or more could be used, and applicability equal to that of vinyl chloride wallpaper was verified. In the burning test of these pulp fiber wallpapers, the smoking and heat value at the burning were small and noxious halogen gas, as seen in the case of vinyl chloride wallpaper, was not generated. Furthermore, the nonwoven fabric layer in the wallpaper stock paper underwent less reduction in the bulk density, a deep and tall concave-convex pattern was formed by heat embossing, the convex part had soft touch, and a wallpaper having high-grade appearance was formed.

On the other hand, in the case of the pulp fiber wallpaper of Comparative Example 3, particularly, the emulsion adhesive penetrated into the highly bulky nonwoven fabric layer of the wallpaper stock, the nonwoven fabric layer was reduced in the bulk density to 0.32 g/cm³ by press-bonding and fixed in this state, and the entire thickness was also decreased to 0.4 mm. Due to this reduction in the thickness, the depth of concave and convex by heat embossing on the surface layer of the wallpaper stock was restricted and the voluminous texture was lost, as a result, a wallpaper entirely showing an impaired high-grade appearance was obtained.

In the case of the pulp fiber wallpaper of Comparative Example 4, the bulk density of the spun-lace nonwoven fabric was made 0.20 g/cm³ so as to maintain the volume of the wallpaper stacked material and, as a result, the surface strength was weak and the fiber loss was generated at the gravure printing. Furthermore, due to weak bonding of non-woven fabric fibers, the dimensional stability of wallpaper deteriorated as a result of invasion of moisture in the glue from the edge parts of the wallpaper pieces during the application process, and the obtained wallpaper was poor-looking, as a whole.

As is apparent from these results, the nonwoven fabric-containing wallpaper of the present invention has a structure that a polyolefin-laminated backing paper layer and a non-woven fabric with printability are bonded on respective surfaces of a highly bulky nonwoven fabric layer each by using a hot melt to form a stacked body, therefore, a high pressing force is not necessary at the stacking and bonding for the production of a wallpaper stock paper and the high bulkiness of the nonwoven fabric layer is not impaired, so that a concave-convex pattern having a gentle slope with a sufficiently large difference of altitude can be formed on the front nonwoven fabric layer in the surface side of the wallpaper stock paper with heat embossing by virtue of the cushioning property of the nonwoven fabric layer. As a result, a soft and voluminous wallpaper having an expensive-looking surface can be constituted.

Furthermore, the melt-bonding resin-laminated layer of the backing paper layer is a moisture impermeable and water-resistant layer and, therefore, the glue used for application does not penetrate into the nonwoven fabric layer and the moisture included in the glue is scarcely evaporated from the surface, so that a sufficiently long open time is allowed after coating of the glue for application. In addition, the highly bulky nonwoven fabric layer is water-repellent and does not allow penetration of water from the edges of the wallpaper pieces, and therefore, excellent durability is attained. Also, the water-repellent highly bulky non-woven fabric layer and the front nonwoven fabric layer are fixed by a hot-melt bonding, and therefore, excellent dimensional stability is obtained.

The wallpaper of the present invention is excellent in processability and applicability, does not generate endocrine-disrupting chemical, ensures weathering resistance and can maintain the decorative property over a long period of time, and therefore, this wallpaper is suitably used as a decorative wallpaper which is used by attaching it on a wall or ceiling surface for the purpose of interior decoration.

It will be appreciated by those skilled in the art that, while the invention has been described above in connection with particular embodiments and examples, the invention is not necessarily so limited and that numerous other embodiments, examples, uses, modifications and departures from the embodiments, examples and use may be made without departing from the inventive scope of this application.

1. A wallpaper having a laminated structure comprising a mat finishing film layer formed of a thermoplastic resin film or a front nonwoven fabric layer with printability, stacked thereon a water-repellent pulp fibrous nonwoven fabric layer having a bulk density of 0.05 to 0.3 g/cm³, stacked thereon a polyolefin-laminated backing paper layer, wherein the adhesions of each layer are accomplished by a hot-melt bonding, characterized in that said mat finishing film layer or said front nonwoven fabric layer has a concave-convex pattern formed by applying heat-embossing treatment to said mat finishing film layer side or said front nonwoven fabric layer side.

2. The wallpaper according to claim 1, wherein said water-repellent pulp fibrous nonwoven fabric layer having a bulk density of 0.05 to 0.3 g/cm³ in said laminated structure is a layer consisting of an air-laid nonwoven fabric having a thickness of 500 to 2,000 μm formed from pulp fibers bonded with an acrylic binder which has a water-repellent group or comprise a water-repelling agent, but does not comprise any formaldehyde-generating source.

3. The wallpaper according to claim 1, wherein said mat finishing film layer formed of a thermoplastic resin film comprises an unstretched polyethylene or polypropylene film having a basis weight of up to 30 g/m², the back side thereof forms a weathering resistant printable surface formed by application of a corona discharge treatment thereto.

4. The wallpaper according to claim 1, wherein said front nonwoven fabric layer with printability comprises a wet nonwoven fabric having a basis weight of up to 30 g/m² and a bulk density of at least 0.2 g/cm³, with a weathering resistant printable surface formed on its front surface.

5. The wallpaper according to claim 4, wherein said wet nonwoven fabric contains at least 50 mass % of hemp pulp.

6. The wallpaper according to claim 1, wherein said adhesion accomplished by a hot-melt bonding is carried out by supplying a hot-melt adhesive between each surface by means of a fibrous curtain coating system.

7. The wallpaper according to claim 1, wherein said polyolefin-laminated backing paper layer is formed by melt-extruding the polyolefin material with an extruder onto the surface of said backing paper adjacent to said nonwoven fabric layer, followed by lamination.

8. A method for producing a wallpaper, comprising the following steps:
adhesion of a polyolefin-laminated backing paper onto a water-repellent pulp fibrous nonwoven fabric having a bulk density of 0.05 to 0.3 g/cm³, and
adhesion of said water-repellent pulp fibrous nonwoven fabric onto a mat finishing film layer formed of a thermoplastic resin film or a front nonwoven fabric layer with printability,
wherein the adhesions of each layer are accomplished by a hot-melt bonding, whereby producing a laminated structure, followed by
application of a heat-embossing treatment to said laminated structure at said mat finishing film layer side or at said front nonwoven fabric layer side to form a concave-convex pattern, whereby said wallpaper has a low-bulk density nonwoven fabric layer within the convex regions.
